(19) United States
(12) Patent Application Publication
(10) Pub. No.: US 2004/0239096 A1
(43) Pub. Date: Dec. 2, 2004

(54) Insert option edition process

(76) Inventor: Gilbert S. Garcia JR., San Antonio, TX (US)

Correspondence Address: GILBERT S. GARCIA JR., 9314 RANCHERO DRIVE, SAN ANTONIO, TX, 78240, US

(21) Appl. No.: 10/449,805

(22) Filed: Jun. 2, 2003

(51) Int. Cl. B42D 1/00

(52) U.S. Cl. 281/15.1

(57) ABSTRACT

The INSERT OPTION EDITION concept has not been utilized for the sole purpose of updating an already published reference/collector edition. My edition, which consists of presidential inaugural addresses from 1789 to 2001, can be updated with future presidential inaugurals in the years 2005, 2009, and 2013.

This makes my reference/collector edition of presidential inaugural addresses unique because of its updating capability. The INSERT OPTION extends the reference/collector use of my publication beyond the next twelve years since only upon reaching the presidential inaugural of 2017 will this current publication reach its up-to-date status.

Although simple in concept, the INSERT OPTION process has not been used as an accepted, routine, update method process, especially in the area of reference/collector type editions.

I am of the opinion that this “new and useful process” once introduced into the market will result in an entire wave of new publications, especially in regards to reference/collector texts, utilizing this very concept in order to update its related topics. The implications for updating any reference/collector publication through the INSERT OPTION process are endless. Publications featuring maps, annual statistics in sports or industry, car models past/current and in the future, stamps, etc. all these topics once published can be updated, therefore eliminating the need for an entire new publication. The INSERT OPTION will result in a new product for sale: “inserts” specifically designed to “UPDATE” an already purchased publication.

The INSERT OPTION is a “first” as described and I, therefore, claim this particular and distinct process as clearly innovative, new and useful, as well as, revolutionary within the publication industry of reference and collector type editions.

### SECTION I: BACKGROUND NEW AND USEFUL PROCESS

The “Insert Option” capability within this publication is made possible because of the use of permanent adhesive paper. The sample enclosed within the appendix is called Fasson Crack 'N Peel Plus high gloss white, cast costed 60# with permanent adhesive.

Although uses for this type of permanent adhesive paper has been used to correct misprints for example in a yearbook or on a page(s) of an already published book, the process has not been used, to my knowledge or research, for the purpose of “updating” an already published edition with new and timely related information.

The concept of adding blank pages to a publication for the purpose of attaching printed updates through the use of permanent adhesive paper is innovative for a reference book of a collection nature. Currently, no reference book has been found in the numerous library books researched that contain this concept of “updating” an already published edition. Separate smaller volumes in the form of updates have been found, but none with the innovative approach, as described, of allowing for “updates” within the same edition.

### SECTION II. SUMMARY OF NEW AND USEFUL PROCESS

My publication contains a section of blank pages within the body of the edition for the specific purpose of “updating” with the addition of future presidential inaugural addresses. These future inaugural addresses will be printed onto the permanent adhesive paper and once peeled off reattached onto the blank pages within the publication. In order to indicate this capability the term “Insert Option Edition” (Trade Mark name) has been placed on the title page. The term itself reflects a capability that the edition has been designed with a particular length of extended time in mind. This particular edition contains inaugural addresses from George Washington (1789) to George W. Bush (2001) but will also allow for three specific future presidential inaugural addresses (years 2005, 2009 & 2013) to be inserted. The printing of “updates” through the use of permanent adhesive paper, an available technology, onto the provided twenty blank pages within the edition as described makes this new and useful process possible.

### SECTION III. DETAILED DESCRIPTION OF NEW AND USEFUL PROCESS

This new and useful process, in particular, allows this edition to (1) be published in 2003 containing a collection of presidential inaugurals from 1789 to 2001 and (2) to be extended beyond the next scheduled inaugural address in the year 2005, at which time it would normally be outdated. Actually, this process extends the life of the edition for sixteen years until the presidential inaugural of 2017 at which time this particular edition (2003) would reach its final inaugural address collection capability. No current reference book has this type of capability nor has any been found that has ever used the process of printing new information onto permanent adhesive paper in order to be attached to blank pages found within a publication.

### SECTION IV. CLAIM

No current reference book/publication of this nature (a collection of presidential inaugural addresses) has the capability of being updated through the following conditions:

Incorporating twenty blank pages within the body of the edition for the sole and specific purpose of “updating” via printed future presidential inaugural addresses onto permanent adhesive paper.

Creating a major distinction within the market due to the capability of extending the publication's usage by an additional sixteen years from its original year of publication.

Revolutionizing the capability of this or any other sort of publication in the following manner:

THE PUBLICATIONS VALUE AND USE is increased due to the nature of the “updating” capability for a set number of additional years.

LESS PAPER is the result, since the current edition does not need to be republished every four years solely for the purpose of “updating” (i.e., in regards to my publication, 317 pages do not need to be reprinted for the sole purpose of an additional six pages, for example).

LIBRARIANS, in particular, may consider this type of publication as cost effective since only a minimal fee for inserts would be the case versus full price for an updated edition.

A MAJOR SOLUTION for updating a collection of presidential inaugurals within a publication with only a four year “up to date” timeline is now possible. Further, this innovation could increase collection type publications as the result of this new and useful process.

### SECTION V: ABSTRACT OF THE DISCLOSURE

The “Insert Option Edition” concept within a publication indicates that the publication has “updating” capabilities for a set number of upcoming years. By printing new information onto permanent adhesive paper, a publication can now be “updated” by attaching the permanent adhesive paper to blank pages within a designated section in the publication. This reference book, in particular, published in the year 2003 contains a collection of presidential inaugural addresses from 1789 to 2001 and yet can be updated with three additional future inaugural addresses, 2005, 2009, & 2013. The claim basically reflects that this edition is the only publication that has taken an available technology of permanent adhesive paper and created a new and useful process by attaching new information onto provided blank pages within the publication. This presidential reference book is distinctively different than any other such reference book due to its “updating” capability.

### SECTION VI: APPENDIX

A. Publication Title Page: Indicating term, INSERT OPTION EDITION (Page 7).

B. Table of Contents: Indicating Section II, blank pages for inserts (Page 8).

C. Section II Sheet: Indicating location for inserting future presidential inaugural addresses (Page 9).

D. See paper copy for sample of permanent adhesive paper (Page 10).

1. What I claim as my invention (ie., new and useful process) is the concept of allowing for the updating of reference/collector type publications through a specific approach called an INSERT OPTION. In order to allow for the updating of already printed materials utilizing the INSERT OPTION, the following conditions must exist: (1) a publication includes an identified section consisting of blank pages, (2) instructions as to how to update the edition through the use of permanent adhesive paper is provided, and (3) the term INSERT OPTION EDITION is clearly indicated on the publication and/or edition.
The INSERT OPTION, therefore, makes it possible to extend the reference/collection capability of a publication up to a limited extended period of time beyond its original publication year. No such capability, regardless of the simplicity of the process, currently exists or can be found as common use within the current market.
